(19) United States
(12) Patent Application Publication
(10) Pub. No.: US 2026/0285140 A1
(43) Pub. Date: Sep. 24, 2026

(54) SINGLE SPEED TWIN SHAFT GEARBOX

(71) Applicant: BAE Systems Controls Inc., Endicott, NY (US)

(72) Inventors: Mario C. DeSantis, Camillus, NY (US); Richard Mizon, Fayettville, NY (US); Mark A. Walker, Vestal, NY (US)

(21) Appl. No.: 19/084,165

(22) Filed: Mar. 19, 2025

(51) Int. Cl. B60K 6/36; F16H 55/08

(52) U.S. Cl. CPC B60K 6/36; F16H 55/0806; F16H 2055/0893

(57) ABSTRACT

A single speed twin shaft gearbox for medium-duty vehicles and heavy-duty vehicles including commercial, military, and maritime vehicles is provided. The gearbox is configured to exceed the expected life cycle of the vehicle by reducing Design and Manufacturing induced transmission Error (TE). The gearbox comprises an input gear and an output gear, each having a different number of helical teeth. The number of teeth in the input gear and the output gear have no common factors between them and provide for about 2.3 to about 2.6 axial helical tooth contact overlap and a 1.3 to 1.6 Involute/Radial contact overlap. The gears have an active face width between about 80 mm and about 90 mm. A distance between respective centers of the gears is between about 135 mm and about 145 mm. The input gear is connectable to an electric machine and the output gear is connectable to the load.

### FIELD OF THE DISCLOSURE

This disclosure is related to gearboxes. More particularly, the disclosure relates to a single speed twin shaft gearbox having helical gearsets.

### BACKGROUND

Medium-duty vehicles and heavy-duty vehicles have operational duty cycles which are very load and cycle count intensive. For example, a transit vehicle has a duty cycle that creates high numbers of transmission gear tooth surface wear cycles. Given the continuous use of the vehicle, it is difficult to have a periodic wear maintenance interval, which means that the gearset must be able to withstand the wear and acceptably perform for a whole expected life cycle of the vehicle. The typical life cycle may be “12 years” or 621373 miles.

Moreover, depending on the type of vehicle such as an electric or a hybrid electric, the electric machine may also stress the gearset. For example, hybrid electric motors impart high torque into a transmission gearbox at a higher rate. This is particularly true during regenerative breaking where there is an equal reverse torque (opposite direction from normal propulsion).

### SUMMARY

Accordingly, disclosed is a single speed Twin Shaft gearbox for class 4, 5, 6, 7, and 8 commercial or military land vehicles or a maritime vehicle. The single speed Twin Shaft gearbox comprises a housing, an input gear, and an output gear. The housing comprises a front portion and a rear portion. Both the front portion and the rear portion have an opening for pass through of Input and Output Gear connection shafts. The input gear has a first plurality of helical teeth and the output gear has a second plurality of helical teeth. The input gear is connectable to an electric machine via the opening in the front portion. The electric machine may be in the vehicle. The output gear is connectable to a load via the opening in the rear portion. A number of teeth in the input gear and the output gear have no common factors between them. The input gear and the output gear have an active face. This active face has a width between about 80 mm and about 90 mm. A distance between a center of the input gear and a center of the output gear is between about 135 mm and about 145 mm.

In an aspect of the disclosure, the input gear and the output gear have a Diametral pitch of between about 12 and about 16.

In an aspect of the disclosure, a number of teeth of the input gear and the output gear in contact at a time is greater than about 2.3 to about 2.6 axial helical tooth contact overlap.

In an aspect of the disclosure, the teeth of the input gear and the output gear in contact have a Involute/Radial tooth contact overlap ratio that is greater than about 1.3 to about 1.6.

In an aspect of the disclosure, each helical tooth has a helix angle between about 12 degrees and about 20 degrees.

In an aspect of the disclosure, the gearbox may further comprise two sets of tapered roller bearings. A first set of the two sets may be mounted to the ends of the input gear and a second set of the two sets may be mounted to the ends of the output gear.

In an aspect of the disclosure, the gear ratio is about 2:1 to about 4:1.

Also disclosed is a vehicle having the single speed Twin Shaft gearbox in accordance with one or more aspects of the disclosure. The vehicle may have an electric machine with an output shaft and the input gear may be connected to the output shaft of the electric machine via the opening in the front portion of the gearbox. The vehicle also may have a load having an input driveshaft and the output gear may be connected to the input driveshaft of the load via the opening in the rear portion.

In an aspect of the disclosure, the vehicle may be a class 4, 5, 6, 7, and 8 commercial or military vehicle or a maritime vehicle.

In aspect of the disclosure, the vehicle may be a transit bus. The transit bus may be an electric vehicle or a hybrid electric vehicle. In other aspects of the disclosure, the military vehicle may be a parallel or series hybrid vehicle. In other aspects, the maritime vehicle may be a series hybrid electric vehicle.

Also disclosed is a method of providing the single speed twin shaft gearbox in accordance with one or more aspects of the disclosure and installing the single speed Twin Shaft gearbox in a vehicle by connecting the output shaft of the electric machine to the input gear and the input shaft of the load to the output gear.

### BRIEF DESCRIPTION OF THE DRAWINGS

FIG. 1 illustrates an exploded view of a single speed Twin Shaft gearbox in accordance with aspects of the disclosure;

FIG. 2 illustrates a perspective view of the gearset of the single speed Twin Shaft gearbox in accordance with aspects of the disclosure showing the center distance between the input gear and output gear;

FIG. 3 illustrates a sectional view of the single speed Twin Shaft gearbox in accordance with aspects of the disclosure;

FIG. 4 illustrates a view of the input gear and the output gear with locating Center Distance;

FIG. 5 illustrates a zoomed view of the input gear and the output gear showing the line of action and number of teeth in contact in accordance with aspects of the disclosure; and

FIG. 6 illustrates a profile of the teeth for the input gear and output gear in accordance with aspects of the disclosure.

### DETAILED DESCRIPTION

Disclosed is a gearbox such as a single speed Twin Shaft gearbox 1 (“Twin Shaft gearbox” or “gearbox”) for Medium-duty vehicles and heavy-duty vehicles such as commercial and military vehicles. The Twin Shaft gearbox may also be used for maritime vehicles. The gearbox has a gearset 10, 12 designed to meet and exceed the expected life cycle of the vehicle. The vehicle may be an electric vehicle or a hybrid electric vehicle. The vehicle may be either a series or parallel hybrid electric vehicle. For example, the vehicle may be a transit bus such as a series or parallel hybrid electric transit bus. In other aspects, the maritime vehicle may be a series hybrid vehicle.

Land vehicles such as commercial vehicles are classified by weight. For the purposes of this disclosure, vehicle classifications are defined as follows:

Class 4: Vehicles between 14,001 and 16,000 lbs, such as city delivery trucks, conventional vans, landscape utility and large walk in.

Class 5: Vehicles between 16,001 and 19,500 lbs, such as bucket trucks, city delivery and large walk-in.

Class 6: Vehicles between 19,501 and 26,000 lbs, such as beverage trucks, rack trucks, school buses, single axle vans and stake body trucks.

Claim 7: Vehicles between 26,001 and 33,000 lbs, such as city transit buses, furniture trucks, high profile semis, home fuel trucks, medium semi tractors, refuse trucks and tow trucks.

Class 8: Vehicles between 33,001 lb and over such as cement mixers, dump trucks, fire trucks, fuel trucks, heavy semi tractors, refrigerated vans, semi sleepers and tour buses.

“Gear ratio” is defined as the number of teeth on the output gear divided by the number of teeth on the input gear.

“Pitch diameter” is the theoretical diameter for which the widths of the teeth and the spaces are equal”.

“Diametral pitch” (DP) is a ratio of the number of teeth to the pitch diameter.

“Base diameter” is the diameter of the base circle from which the tooth profile is developed.

“Twin shaft” means that the gearbox has two shafts: an Input and an Output, one for connection to an electric machine such as a generator or motor and another for connection to a load such as a drive shaft (also referred to as a propeller shaft) which may be in turn connected to a differential and wheel axles of the vehicle. The twin shaft axes are parallel.

“Center distance” (CD) is the center line distance between the two shafts of the input gear 10 and the output gear 12.

“Transmission Error (TE)” is defined as the efficient transmission of rotational velocity from the Input Gear 10 to the Output Gear 12. Transmission Error (TE) has two main components: Design induced Transmission Error (“Design Transmission Error) and Manufacturing induced Transmission Error (“Manufacturing Transmission Error”). Whereas, tooth/shaft location and tooth flank surface inaccuracies (such as due to manufacturing), lead to a rotational velocity transfer variation of the Input and Output Gear teeth which is the Transmission Error(TE) and is a cause of Gear Mesh Noise.

A medium-duty vehicle may be a vehicle above 14,001 lbs. A heavy-duty vehicle may be a vehicle above 26,001 lbs.

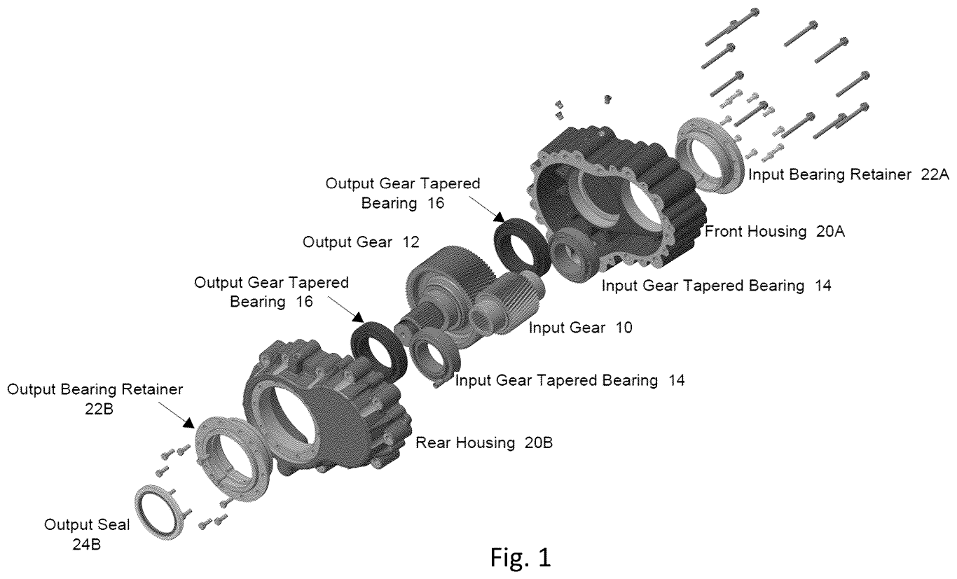

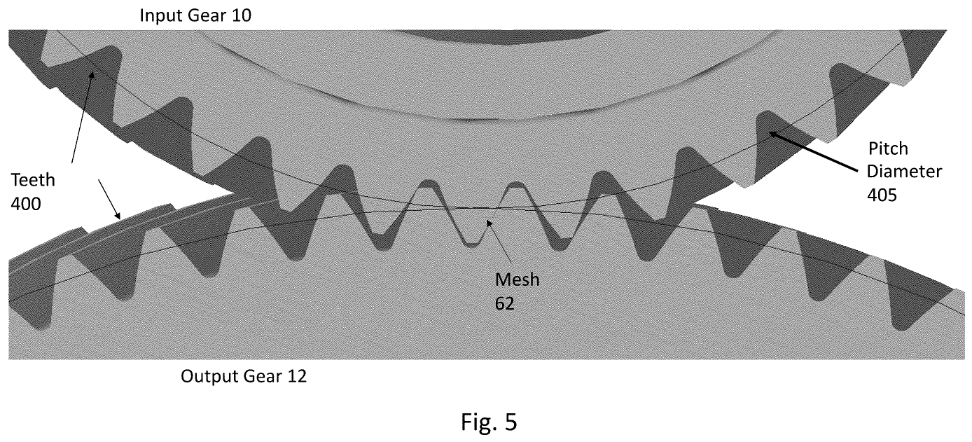

As shown in FIG. 1, the Twin Shaft gearbox 1 in accordance with aspects of the disclosure comprises an input gear 10 (also referred to as pinion) and an output gear 12 (also referred to as a gear) collectively referred to as gearset 10, 12. The input gear 10 meshes with the output gear 12 such mesh 62 is shown in FIG. 5. The input gear 10 may be smaller than the output gear 12. The gearset may increase or decrease the speed of rotation with respect to an output shaft of an electric machine or a load speed. The gear ratio determines the increase/decrease in the speed of the rotation.

In an aspect of the disclosure, the type of vehicle (e.g., electric or hybrid) and the specific electric machine may include a twin shaft gearbox 1 configured in accordance with one or more aspects of the disclosure. For example, every electric machine design has a different torque output and operational efficiency point. The gear parameters are configured according to the torque for the “Duty Cycle” profile for the vehicle it will be used in. This means, for every different electric motor and every different vehicle class type, a different duty cycle is set and the gear parameters are configured.

In an aspect of the disclosure, the gearset 10, 12 may be helical gears where the teeth spiral around the body of the gears at a defined helix angle. The helix angle is the angle of the tooth is the axial direction (lengthwise) with respect to an axis of rotation of the gear. One of the gears may be arranged as left-handed and the other arranged as right-handed. For example, the input gear 10 may be left-handed and the output gear 12 may be right-handed.

The Twin Shaft gearbox 1 has a front housing 20A and a rear housing 20B. Each housing 20A and 20B has a respective opening for a shaft of the respective input or output gear 10, 12. For example, the front housing 20A has an opening for a shaft of the input gear 10 and the rear housing 20B has an opening for the shaft of the output gear 12. The front housing 20A and the rear housing 20B have a combined width (in the axial direction of the gearset) having a preset size. This preset size may be based on the vehicle in which the gearbox 1 is installed. For example, different vehicles may have different size areas for the gearbox 1 to fit into (footprint). The footprint may account for required clearances between the different components of the vehicle. In an aspect of the disclosure, the combined width of the front housing 20A and the rear housing 20B may be the maximum width allowable for the footprint.

In an aspect of the disclosure, the length of the front housing 20A and the rear housing 20B may also be based on the allowable footprint within a vehicle. For example, the length may also be the maximum allowable within the footprint.

In an aspect of the disclosure, the front housing 20A and the rear housing 20B material may be Cast Iron so as to more closely match CTE (thermal characteristics) of the gearing, improve Gearbox housing stiffness and reduce Transmission Error (TE) due to shaft separation or misalignment and realizing Cast Iron's ability to minimize differential thermal effects that could lead to variations in axial and radial clearances along with the ability to reduce airborne Gear meshing noise.

The Twin Shaft gearbox 1 also comprises bearings 14, 16. There are bearings for the input gear 10 (bearings 14) and bearings for the output gear 12 (bearings 16). In an aspect of the disclosure, the bearings may be tapered bearings. Tapered bearings can handle both axial and radial forces. Since, in an aspect of the disclosure, helical gears are used, the gears 10, 12 produce both axial and radial forces. Tapered bearings are also good for high rotational speeds. Additionally, since the bearings are tapered, they take up less space than other types of bearings and for their size and footprint, typically have a higher load rating. Additionally, tapered bearings better axially and radially locate gear shafts to each other to reduce misalignment and Transmission Error (TE). However, while tapered bearings are shown in the figures, such as FIGS. 1-3, other types of bearings may be used.

Each gear 10, 12 has a connection shaft portion and a toothed portion. The tooth portion may be in a central portion of a shaft where the ends of the shaft are exposed. The tapered bearings are positioned on the each of the gears around the toothed portion which enables the shafts to smoothly rotate.

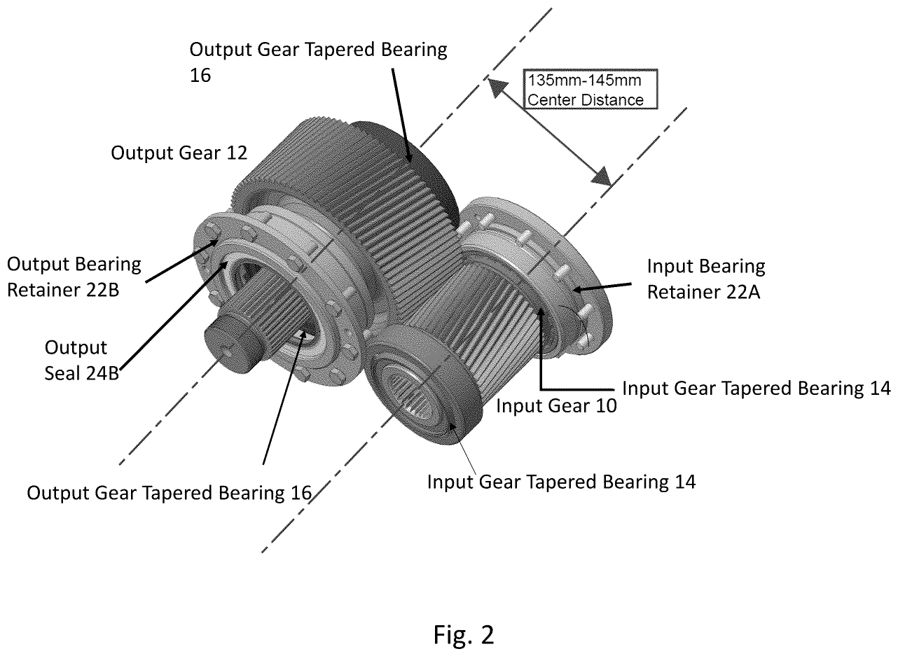

The input gear tapered bearings 14 are placed on both sides of the input gear 10. For example, one input gear tapered bearing 14 may be placed around a first side (Front side) of the toothed portion of the input gear 10 and another input gear tapered bearing 14 may be placed around a second side (Rear side) of the toothed portion of the input gear 10 as shown in FIG. 2 such that the teeth 400 are located between the input gear tapered bearings 14. The front side may also be referred to as the input side and the rear side may be referred to as the output side. When assembled, one of the input gear tapered bearings 14 sits within the opening of the front housing 20A where the input connection side of the input gear 10 is exposed from the gearbox 1 to be connected to an output shaft of the electric machine of the vehicle. The corresponding portion of the rear housing 20B has a slot or seat for the other of the input gear tapered bearing 14 to sit within. The output side or rear of the toothed portion of the input gear 10 is not exposed from the gearbox 1 and sits within the slot or seat of the rear housing 20B. Similarly, the front housing 20A has a slot or seat for one of the output tapered bearings 16 to sit within and is not exposed from the gearbox 1 on the input housing side.

Similarly, output gear tapered bearings 16 are placed on both sides of the output gear 12. For example, one output tapered bearing 16 may be placed around the front side of the toothed portion of the output gear 12 and another output gear tapered bearing 16 may be placed around the rear side of the toothed portion of the output gear 12 as shown in FIG. 2 such that the teeth 400 are located between the output gear tapered bearings 14. One of the output gear tapered bearings 16 sit within the opening of the rear housing 20B where an output connection side of the output gear 12 is exposed from the gearbox 1 to be connected to the vehicle driveshaft of the load. This bearing arrangement situated on either side and as close to the Input and Output gears 10 and 12 respectively, is configured to minimize shaft deflections and subsequently decreasing Transmission Error (TE) and Gearbox Mesh noise.

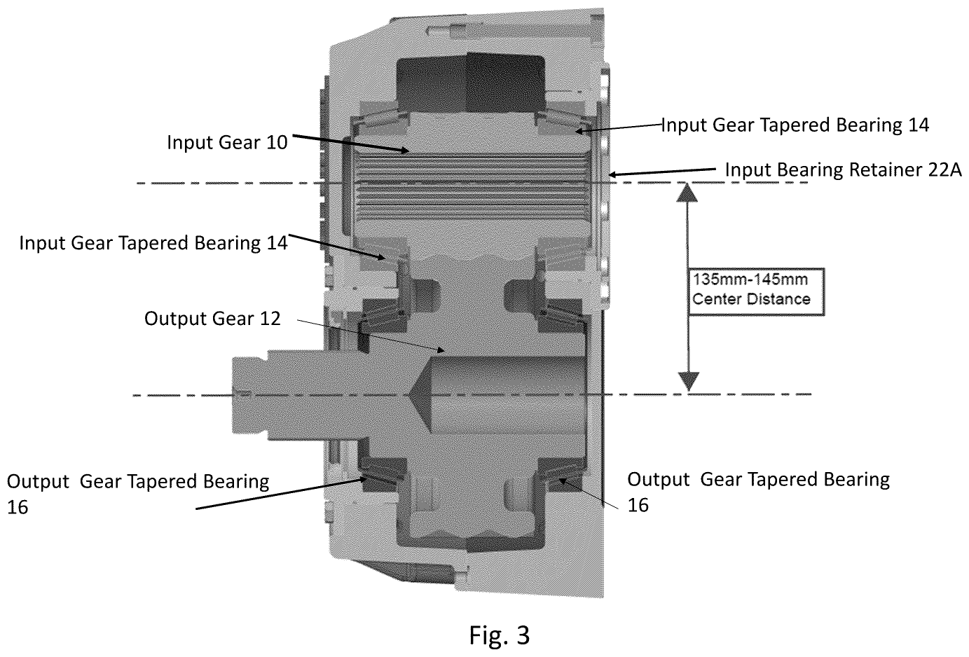

The Twin Shaft gearbox 1 also comprises bearing retainers 22A, 22B. The input bearing retainer 22A may be used for the front housing 20A and output bearing retainer 22B may be used for the rear housing 20B. The retainers 22A, 22B are positioned in the respective openings on the housing. The retainers 22A, 22B support the tapered bearings 14, 16, and are configured to maintain the outer raceways of the tapered bearings from moving while the inner raceways rotate with the gears 10, 12. The outer and inner raceways are shown in the sectional view (FIG. 3). The taper of the tapered bearings is shown by the angled rollers between the bearing raceways.

The bearing retainers 22A, 22B may be attached to the respective housing 20A, 20B using any known securing means such as screws or bolts. The two pieces of the housing 20A, 20B may be respectively attached to each other using a similar securing means. FIG. 2 shows the input bearing retainer 22A surrounding the one of the input gear tapered bearings 14. In FIG. 2, the front housing 20A is not shown to enable the view of the internal components. This bearing retainer configuration for the Input and Output gears 10 and 12 respectively, is configured to minimize shaft location variation, ease of assembly and to repeatedly align the meshed gears and shafts as parallel end to end to subsequently decrease Transmission Error (TE) and improve Gearbox Mesh noise.

The Twin Shaft gearbox 1 also comprises a seal 24B. The seal 24B may be placed in the output bearing retainer 22B which seals the vehicle driveshaft connection. In an aspect of the disclosure, the front housing 20A may also have a seal (not shown in the figures). This seal may be incorporated into a mating motor gearbox centering pilot which is on the front housing 20A. The seal may be an O-ring. The O-ring may be proud of the gearbox centering pilot diameter. This seal may keep motor and gearbox lubricants from entering an environment. The seal may also prevent environmental contaminants to ingress to the Twin Shaft gearbox 1 or motor.

In an aspect of the disclosure, the Twin Shaft gearbox 1 and gearset is configured to achieve a predetermined total contact ratio which enables the Twin Shaft gearbox 1 to meet the life cycle of the vehicle (hereinafter total helical gear contact ratio). The life cycle may be prescribed by a vehicle manufacturer or user (also referred to as customer). The total helical gear contact ratio is made up of a radial component of contact overlap and an axial component of the contact overlap. The total helical gear contact ratio is a sum of the two components: Radial and Axial. The Total Helical gear contact ratio measures an overlap between the teeth 400 of the gearset 10, 12 in these respective directions. In an aspect of the disclosure, the total Helical gear contact ratio may be 3.982 with the Axial contact ratio being 2.5454 and the Radial or Involute contact ratio being 1.4366. In other aspects, the Total Helical gear contact ratio may be above 2 and the Radial or Involute contact ratio may be above 1. These ratios are configured to achieve efficient smooth Gear meshing or rolling and reduce Transmission Error (TE) or mesh misalignment which is described as gear pair rotational efficiency which is a main contributor to reduced gear mesh noise in electric drive and powertrain gearboxes to be discussed further in the disclosure.

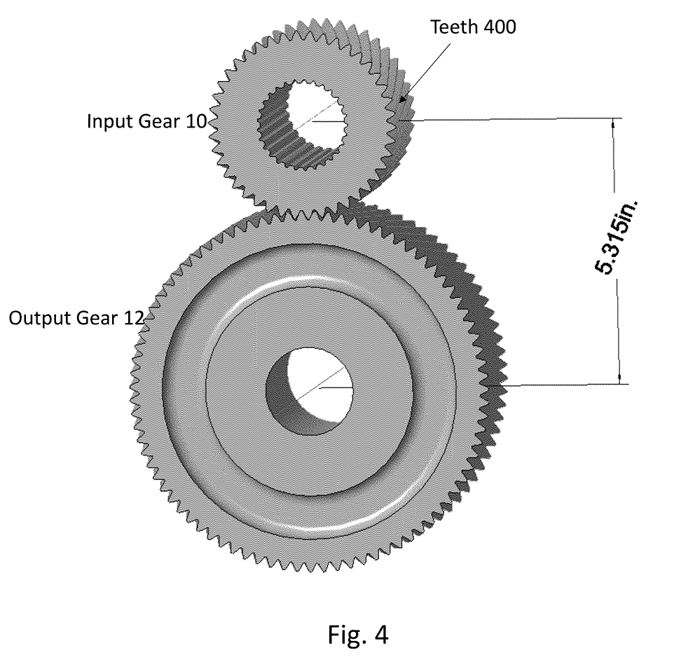

The radial component is related to a tooth height in both the input gear 10 and the output gear 12. An example of the relative tooth heights is shown in FIGS. 4-6.

In an aspect of the disclosure, the input gear 10 has a predetermined number of teeth. The predetermined number may be greater than a specific value, e.g., minimum tooth count. For example, the predetermined number of teeth may be 35. In other aspects, the predetermined number of teeth may be 40. For example, the input gear 10 may have 42 teeth (and the output gear may have 83 teeth). The number of teeth in the input gear 10 and the output gear 12 may be based on a target gear ratio. For example, the gear ratio may be about 2:1 or about 4:1 (such as 1.9762 for 83:42). The target gear ratio (total helical gear contact ratio) may be based on the type of vehicle and the electric machine such as based on the efficiencies of the electric machine. The predetermined number of teeth on the input gear 10 may be based on a durability requirement of the gearbox 1. For example, a high tooth count of the input gear 10 allows for a continuous smooth tooth action such that when one pair of teeth (input gear and output gear) loses contact with each other, other pair(s) of teeth are already engaged. However, it is noted that the tooth count in each gear 10, 12 may impact the pitch diameter because as the tooth number of teeth change and the “thickness” changes, the pitch diameter may also change.

The maximum center distance CD is limited by the footprint of the gearbox in the vehicle and the size of the input gear 10 and output gear 12. A larger center distance is directly related to gear strength. However, as the center distance CD increases, there may be an increase in backlash. In an aspect of the disclosure, the center distance CD may be based on the type of vehicle and the space such as the maximum allowable CD within the footprint available in the vehicle. In some aspects of the disclosure, the center distance CD may be between about 135 mm and about 145 mm such as shown in FIG. 2 and FIG. 3 (where 135 mm is about 5.315 inches such as shown in FIG. 4). However, where the vehicle supports a larger gearbox (in length), the center distance CD may also be selected to be larger if greater durability is required.

In an aspect of the disclosure, the gearset 1 may have a Diametral pitch between about 12 and about 16 providing a fine tooth count. The fine tooth count achieves a lower Transmission error (TE) relative to a coarse tooth count (lower DP). The DP may change depending on the size of the gears 10, 12. Larger gears 10, 12 may support a larger range for the DP.

The helix angle impacts both the radial and the axial component of the total helical gear contact ratio. For example, increasing the helix angle, increases the length of the contact of the teeth in the axial direction, e.g., the overlap becomes longer (for the same gear width). However, the increase in axial overlap increases the thrust load on the tapered bearings 14, 16. In accordance with aspects of the disclosure, the helix angle may be about 10° to about 22° to account for both the total helical gear contact ratio and the thrust load on the bearings. In other aspects, the helix angle may be about 12° to about 20°. FIG. 3 illustrates a sectional view of the Twin Shaft gearbox 1. The axial length of the teethed portion is set to be the maximum length available in the gearbox housing 20A, 20B between the tapered bearings 14, 16.

In an aspect of the disclosure, the teethed portion(s) of the input gear 10 has a width of about 80 mm to about 90 mm. Having the width greater than 80 mm provides an axial component of the total helical gear contact ratio greater than about 2.3 or 2.6. In an aspect of the disclosure, the width of the teethed portion may be set to a maximum width allowable within the footprint for the gearbox 1 accounting for the shafts, tapered bearings 14, 16, housing 20A, 20B and retainer 22A, 22B. For example, the axial contact ratio may be 2.54.

In an aspect of the disclosure, the gear configuration is a hunting ratio. A hunting tooth relationship in gear pairs means that there is no common denominator between the number of teeth on gears 10, 12, respectively. As a result, every tooth of the Input Gear will mesh with every tooth space of the meshing gear. After all teeth and spaces have been rolling with each other on gears 10, 12, respectively, the cycle repeats after the Output Gear 12 performs a number of revolutions equal to the number of teeth on the Input Gear. For example, a tooth in the input gear 10 and a corresponding tooth in the output gear 12 do not repeatedly come in contact with each other in one revolution, but contact each other again in X revolutions of the Output Gear 12. Thus, it takes a period of time for the same teeth to repeat contact with each other. This significantly improves wear and gear mesh noise as compared to non-hunting ratios by spreading out wear cycles across as many teeth as possible, not allowing individual teeth to develop a consistent flank wear pattern and breaking-in with the greatest number of corresponding teeth on the Output Gear 12. For example, there may be 42 teeth in the input gear 10 and 83 teeth in the output gear 12 which do not have a common factor. A hunting tooth gear design allows for improved gear tooth surface wear by shifting the high load contact areas on a given tooth due to manufacturing inaccuracies where the teeth are not ‘perfect’ flank-to-flank contacts over several different meshed teeth, whereas the meshing teeth ‘distribute’ the surface wear over the whole surface of the tooth due to the tooth flank contact area manufactured differences of all of the corresponding gear set teeth, “breaking-in or wearing-in” the tooth flanks to be and “average” surface wear and manufacturing high spot location. This leads to another benefit of a hunting ratio is reduction in gear mesh noise whereas due to the ‘same tooth’ not coming into contact with its initial meshing tooth repeatedly in one revolution. Where again, the manufactured radial location of that initial meshed tooth flank to the gear centerline, called dimensional ‘Runout’ or deviation from the gear center line, naturally has a changing radial location due to variations in manufacturing which can increase gear meshing noise and wear. A hunting tooth configuration presents the starting mesh tooth to ‘different’ meshed teeth which significantly reduces the hysteresis of the meshing ‘runout’creating lower mesh noise.

This reduction in radial location or variation in gear meshing of each component is another advantage of the aforementioned gearset configured which is to lower Transmission Error (TE) which has been defined as the efficient transmission of rotational velocity from the Input Gear 10 to the Output Gear 12. The tooth/shaft location and tooth flank surface inaccuracies as described above, lead to a rotational velocity transfer variation which is the Transmission Error (TE) and is a cause of Gear Mesh Noise. The aspects of the disclosure have also been set to minimize the Manufacturing and Design Transmission Error (TE) including but not limited to the Total helical gear Contact ratio (e.g., 3.982) with a Involute Contact overlap (e.g., 1.4366) and an Axial contact ratio (e.g., 2.545). For example, these ratios reduce Operational Gear noise.

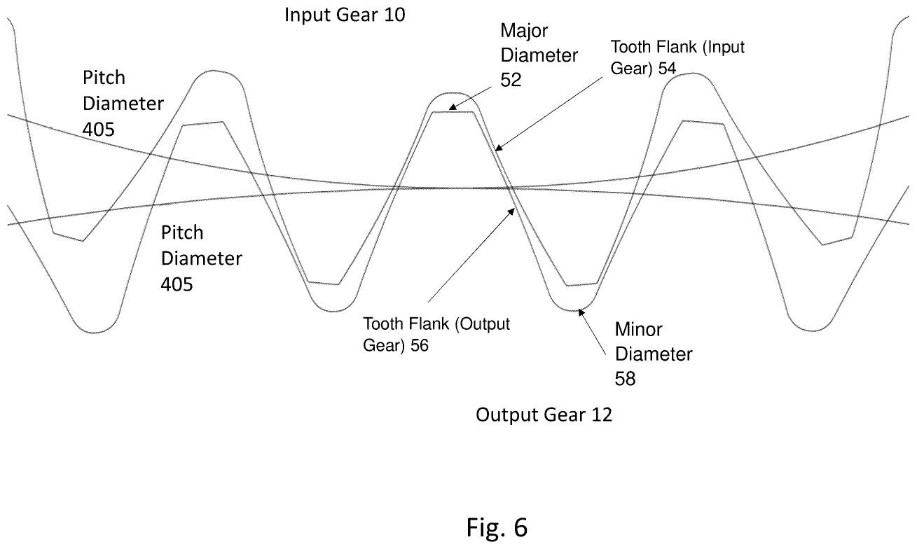

FIG. 5 illustrates a zoomed view of the gears 10, 12 showing how multiple teeth 400 are in mesh 62 at the same time: in this example, the axial overlap contact ratio is 2.54. Referring to FIG. 6, each tooth 400 extends between the minor diameter 58 and the major diameter 52. In an aspect of the disclosure, the input gear 10 and the output gear 12 have involute curved flank 54, 56 to facilitate smooth transitions in the mesh. As shown in FIG. 6, each tooth 400 has a basic rack profile. The minor diameter 58 has a bottom clearance, e.g., space between the root and the tip of the tooth.

The pitch diameter 405 (pitch circle) is superposed on the input gear 10 and the output gear 12 in FIGS. 5 and 6. This defines the point where the teeth of the input gear 10 and the output gear 12 mesh.

A tooth flank 56 (of the output gear 12) meshes with the tooth flank 54 (of the input gear 10) of the corresponding tooth. When this set of teeth are in contact, since more than one set of teeth is in contact at a time, an adjacent tooth of the input gear 10 and its corresponding tooth on the output gear 12 are also in contact. FIGS. 5 and 6 shows an example of this contact at a specific point in time.

It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative aspects of the disclosure.

While various inventive aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive aspects described herein. It is, therefore, to be understood that the foregoing aspects are presented by way of example only and that, within the scope of the appended claims and equivalents thereto, inventive aspects may be practiced otherwise than as specifically described and claimed. Inventive aspects of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one aspect, to A only (optionally including elements other than B); in another aspect, to B only (optionally including elements other than A); in yet another aspect, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one aspect, to at least one, optionally including more than one, A, with no B present (and optionally including elements other than B); in another aspect, to at least one, optionally including more than one, B, with no A present (and optionally including elements other than A); in yet another aspect, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed aspects teach the features of components A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one aspect, the features and elements so described or shown can apply to other aspects. It will also be appreciated by those of skill in the art that references to a structure or feature that is disposed “adjacent” another feature may have portions that overlap or underlie the adjacent feature.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An aspect is an implementation or example of the present disclosure. Reference in the specification to “an aspect,” “one aspect,” “some aspects,” “one particular aspect,” “an exemplary aspect,” or “other aspects,” or the like, means that a particular feature, structure, or characteristic described in connection with the aspects is included in at least some aspects, but not necessarily all aspects, of the invention. The various appearances “an aspect,” “one aspect,” “some aspects,” “one particular aspect,” “an exemplary aspect,” or “other aspects,” or the like, are not necessarily all referring to the same aspects.

If this specification states a component, feature, structure, or characteristic “may”, “might”, or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various aspects of the disclosure are examples and the disclosure is not limited to the exact details shown or described. The terminology used herein is for the purpose of describing particular aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A single speed Twin Shaft gearbox for class 4, 5, 6, 7, and 8 commercial, military vehicle or a maritime vehicle, the single speed Twin Shaft gearbox comprising:
a housing comprising a front portion and a rear portion;
an input gear being connectable to an electric machine of the commercial, military vehicle or maritime vehicle via an opening in the front portion, the input gear comprising a first plurality of helical teeth;
an output gear being connectable to a load via an opening in the rear portion, the output gear comprising a second plurality of helical teeth, a number of teeth in the input gear and the output gear have no common factors between them,
each of the input gear and the output gear having an active face width, the active face width being between about 80 mm and about 90 mm, and where a distance between a center of the input gear and a center of the output gear is between about 135 mm and about 145 mm.

2. The single speed Twin Shaft gearbox of claim 1, wherein the input gear and the output gear have a Diametral pitch of between about 12 and about 16.

3. The single speed Twin Shaft gearbox of claim 2, wherein a number of teeth of the input gear and the output gear in contact at a time is greater than about 2.3 to about 2.6 axial helical tooth contact overlap.

4. The single speed Twin Shaft gearbox of claim 3, wherein the teeth of the input gear and the output gear in contact have an Involute/Radial tooth contact overlap ratio that is greater than about 1.3 to about 1.6.

5. The single speed Twin Shaft gearbox of claim 1, wherein each tooth has a helix angle between about 12 degrees and about 20 degrees.

6. The single speed Twin Shaft gearbox of claim 1, further comprises two sets of tapered roller bearings, where a first set of the two sets are mounted to the ends of the input gear and a second set of the two sets are mounted to the ends of the output gear, where a distance between the tapered roller bearings for the input gear and the active face width for the input gear and a distance between the tapered roller bearings for the output gear and the active face width of the output gear is set to minimize shaft deflection.

7. The single speed Twin Shaft gearbox of claim 1, wherein the input gear to output gear ratio is about 2:1 to about 4:1.

8. A vehicle comprising:
an electric machine with an output shaft;
a load having an input shaft;
a single speed Twin Shaft gearbox comprising:
a housing comprising a front portion and a rear portion made of Cast Iron;
a input gear being connected to the output shaft of the electric machine via an opening in the front portion, the input gear comprising a first plurality of helical teeth;
a output gear being connected to the input shaft of the load via an opening in the rear portion, the output gear comprising a second plurality of helical teeth, a number of teeth in the input gear and the output gear have no common factors between them,
each of the input gear and the output gear having an active face width, the active face width being between about 80 mm and about 90 mm, and where a distance between a center of the input gear and a center of the output gear is between about 135 mm and about 145 mm.

9. The vehicle of claim 8, wherein the vehicle is a class 4, 5, 6, 7, or 8 commercial or military vehicle or a maritime vehicle.

10. The vehicle of claim 8, wherein the vehicle is a transit bus which is an electric vehicle or hybrid electric vehicle.

11. The vehicle of claim 8, wherein the vehicle is a military vehicle which is a parallel or series hybrid vehicle.

12. The vehicle of claim 8, wherein the vehicle is a maritime vehicle which is a series hybrid electric vehicle.

13. The vehicle of claim 8, wherein the input gear and the output gear have a Diametral pitch of between about 12 and about 16.

14. The vehicle of claim 13, wherein a number of teeth of the input gear and the output gear in contact at a time is greater than about 2.3 to about 2.6 axial helical tooth contact overlap.

15. The vehicle of claim 13, wherein the teeth of the input gear and the output gear in contact have an Involute/Radial tooth contact overlap ratio that is greater than about 1.3 to about 1.6.

16. The vehicle of claim 13, wherein the teeth of the input gear and the output gear in contact have a Total Contact Ratio greater than 2.

17. The vehicle of claim 13, wherein each tooth has a helix angle between about 12 degrees and about 20 degrees.

18. The vehicle of claim 13, wherein the single speed Twin Shaft gearbox comprises two sets of tapered roller bearings, where a first set of the two sets are mounted to the ends of the input gear and a second set of the two sets are mounted to the ends of the output gear.

19. The vehicle of claim 13, wherein the input gear to output gear ratio is about 2:1 to about 4:1.

20. A method comprising:
providing a single speed Twin Shaft gearbox, the single speed Twin Shaft gearbox comprising:
a housing comprising a front portion and a rear portion;
an input gear being connectable to an output shaft of an electric machine via an opening in the front portion, the input gear comprising a first plurality of helical teeth;
an output gear being connectable to an input shaft of a load via an opening in the rear portion, the output gear comprising a second plurality of helical teeth, a number of teeth in the input gear and the output gear have no common factors between them,
each of the input gear and the output gear having an active face width, the active face width being between about 80 mm and about 90 mm, and where a distance between a center of the input gear and a center of the output gear is between about 135 mm and about 145 mm;
installing the single speed Twin Shaft gearbox in a vehicle by connecting the output shaft of the electric machine to the input gear and the input shaft of the load to the output gear.
